(19) United States
(12) Patent Application Publication
(10) Pub. No.: US 2011/0076416 A1
(43) Pub. Date: Mar. 31, 2011

(54) METHOD OF MAKING POROUS MATERIALS AND POROUS MATERIALS PREPARED THEREOF

(75) Inventors: Andreas Klipp, Lambsheim (DE); Norbert Wagner, Mutterstadt (DE); Cyrill Zagar, Hong Kong Central (CN); Andreas Fechtenkötter, Singapore (SG); Chih-Cheng Peng, Singapore Science Park lll (SG); Chien Hsueh Steve Shih, Taipei (TW); Sujandi Sujandi, Singapore (SG)

(73) Assignee: BASF SE, Ludwigshafen (DE)

(21) Appl. No.: 12/993,871

(22) PCT Filed: May 20, 2009
(86) PCT No.: PCT/EP2009/056160

§ 371 Date: Nov. 22, 2010

(30) Foreign Application Priority Data
May 26, 2008 (EP) 08156912.1
Jul. 11, 2008 (EP) 08160228.6

(51) Int. Cl. C08J 9/36; C08J 7/18; C08G 77/60; B05D 5/12

(52) U.S. Cl. 427/487; 521/50.5; 521/77; 521/154; 427/58

(57) ABSTRACT

The present invention concerns a method of making a porous material comprising the following steps in the order a-b-c-d:
(a) reacting at least one organosilane (A) with water in the presence of a solvent (C) to form a polymeric material,
(b) subjecting said polymeric material to a first heat treatment,
(c) bringing said polymeric material into contact with at least one dehydroxylation agent (D),
(d) subjecting said polymeric material to electromagnetic radiation and/or to a further heat treatment.

The present invention furthermore concerns the porous material obtainable by the inventive method, semiconductor devices and electronic components comprising said porous material, and the use of said material for electrical insulation and in microelectronic devices, membranes, displays and sensors.

### DESCRIPTION

The present invention concerns a method of making a porous material comprising the following steps in the order a-b-c-d:
(a) reacting at least one organosilane (A) with water in the presence of a solvent (C) to form a polymeric material,
(b) subjecting said polymeric material to a first heat treatment,
(c) bringing said polymeric material into contact with at least one dehydroxylation agent (D),
(d) subjecting said polymeric material to electromagnetic radiation and/or to a further heat treatment.

The present invention furthermore concerns the porous material obtainable by the inventive method, semiconductor devices and electronic components comprising said porous material, and the use of said material for electrical insulation and in microelectronic devices, membranes, displays and sensors.

Reduction of the feature size in microelectronics is a continuous challenge due to the increase in propagation delay, crosstalk noise, and power dissipation as the dimensions of the device reduce to less than 0.25 μm. The electric resistance of the metal interconnects and parasitic capacitance between metal interconnects is known to increase as the device geometric dimension shrinks and packing density increases. The increase of resistance-capacitance (RC) is known to reduce the overall semiconductor circuits' performance because of the increase of the signal delay time or the so-called RC delay. In order to reduce the RC delay and to improve the speed of the densely packed semiconductor device, it is necessary to use highly conductive metal interconnects in combination with a material having a particularly low dielectric constant.

Suitable low-k materials for use in semiconductor devices need to meet stringent property requirements. In particular, low-k materials must exhibit a high thermal, mechanical, and chemical stability to withstand a temperature in the range of 400-450 ° C. during metal deposition as well as the harsh chemical-mechanical polishing (CMP) process.

Silicon dioxide has been widely used in the prior art as dielectric material partly satisfying these criteria due to its inherent thermal, mechanical, and chemical stability. Usually silica is deposited on suitable substrates via a chemical vapor deposition processes (CVD). However the silica film formed by using chemical vapor deposition (CVD) processes has a comparatively high dielectric constant of approximately 4.

Different attempts have been made to reduce the dielectric constant and at the same time keep the good thermal, mechanical, and chemical stability of silica based materials. In particular, it has been suggested to create a porous structure within the silica matrix to reduce the dielectric constant.

One strategy to create silica materials with a porous structure is the sol-gel route. Methods that start from organosilanes which are subjected to a sol-gel process are known to the person skilled in the art. The porous structure can for instance be introduced by means of so-called porogens, additives causing the formation of pores during film formation, in particular by means of forming micelles. The pores obtained by means of porogens typically result in an average pore size of more than 2 nm. The porous structure obtained by means of porogens, however, frequently collapses during the CMP process.

Combinations of organosilanes with hydrolysable alkoxy groups as precursors which are then subjected to a sol-gel process yielding a porous material are known from the prior art.

JP-A 2001-354771 and JP-A 2003-89769 disclose that a combination of two alkyl-alkoxysilanes or tetraalkoxysilane and alkylalkoxysilane in the presence of an acid catalyst provides a microporous film with a comparatively low dielectric constant. U.S. Pat. No. 7,332,446 discloses that a combination tetraalkoxysilane and alkylalkoxysilane in the presence of a base catalyst leads to a microporous dielectric film with a low dielectric constant. The mechanical stability of these films is insufficient though for many applications. Consequently, the films obtained by these methods usually do not meet the mechanical requirements for present semiconductor fabrication processes.

To improve the mechanical stability of the porous material, it is known from the prior art to use certain bridged organosilanes as a so-called “crosslinking agent” to increase the mechanical stability of the silica network.

US-A 2006/0110940 describes a method of preparing low-k dielectric films using cyclic siloxanes which optionally carry pendant silyl groups and which can be used in combination with bridged organosilanes and/or porogens. However, the use of cyclic siloxanes or bridged organosilanes with three or four silyl groups is limited due to its commercial availability and its tedious synthesis procedure. The mechanical strength of the films prepared according to US-A 2006/0110940 furthermore is not sufficient for many practical applications.

EP-A 1 146 092 discloses a method for making porous films by means of hydrolyzing and condensing a combination of three different organosilanes including a bridged organosilane with two functional Si atoms.

WO-2006/032140 relates to the chemical transformation of bridging organic groups in organosilica materials. By this method, low-k porous films were obtained using bridged organosilane precursors such as 1,2-bis(triethoxysilyl)ethane and a porogen. A thermal treatment at specific temperatures causes the content of surface-hydroxyl groups to decrease and the dielectric constant to increase; UV as an alternative curing means is mentioned. The method suggested does not involve a chemical surface treatment.

However, the mechanical strength of the films obtained using mixtures of precursors including bridged organosilanes is still not satisfactory in particular for a successful Cu-low k interlayer dielectric integration due to the high misfit in the elastic modulus between the dielectrics and the copper.

It is known to the person skilled in the art that if moisture adsorption in the inner structure of the porous material during manufacturing process occurs—at least until such material or component is encapsulated for instance with a thermoset polymer—then it significantly increases its effective dielectric constant. It has been suggested in the prior art to reduce the moisture absorption by reducing the number of free hydroxyl groups on the pore surface through heat treatment and/or silylation with for instance chlorotrimethylsilane.

U.S. Pat. No. 6,583,067 proposes the utilization of a post-treatment of the low k dielectric material to remove Si-OH bonds and to avoid moisture absorption causing deterioration of the dielectric properties. To that end, it has been suggested to use a solution containing hexamethyldisilazane (HMDS).

Similarly, U.S. Pat. No. 7,270,941 describes a method of passivating SiO₂ based low-k materials using a supercritical CO₂ passivating solution comprising a silylating agent. The silylating agent is preferably an organosilicon compound such as HMDS, trichloro-methylsilane (TCMS) or chlorotrimethylsilane (TMCS).

From the prior art, however, it is only known to apply the silylation to the final porous material obtained after calcination, i.e., thermal treatment at high temperatures. However, by means of the methods disclosed by the prior art it is often not possible to obtain and maintain a sufficiently low dielectric constant.

Consequently, there is a need for a dielectric material based on silicon dioxide that has pores with an average pore size of less than 2 nm, i.e. a microporous material according to IUPAC nomenclature, with at the same time high thermal, mechanical and chemical stability.

It was an object of the present invention to provide a method of making a silicon dioxide based material with low dielectric constant and good mechanical properties, at the same time avoiding the disadvantages of the prior art.

The resulting material ought to exhibit high mechanical strength and good dielectric properties during processing, in particular during the CMP. In particular, the porous material ought to have a low dielectric constant. Furthermore, an increase of the dielectric constant due to moisture adsorption ought to be avoided. The hardness and Young's modulus ought to be high. The method ought to be widely applicable to different precursors.

Preferred embodiments of the invention are outlined in the claims and in the description. Combinations of preferred embodiments do not leave the scope of the present invention.

The different steps of the method of making a porous material according to the invention are outlined in the following:

Step (a)

According to the invention, step (a) comprises reacting at least one organosilane (A) with water in the presence of a solvent (C) to form a polymeric material.

A polymeric material in the context of the present invention is a material in which the (former) precursors are present in at least partially polymerized form. Preferably, the polymeric material obtained after step (a) is a sol. The term “sol” is used throughout the present invention to reflect a partially cross-linked polymeric material in the presence of a solvent. A fully cross-linked polymeric material in which no isolated polymer particles are present is referred to as a gel. Preferably, the sol is a polymeric material that is present as particles dispersed in the solvent. Preferably the sol can be converted to a film when the solvent is removed, i. e., the sol is film-forming upon removal of the solvent. The sol preferably has a viscosity such that the fluid, preferably the solvent plus the polymeric material, can be effectively transferred to a substrate by suitable means known to the person skilled in the art.

The term “organosilane” refers to a molecule having at least one organosilane group. An “organosilane group” refers to a Si atom with at least one organic group attached to it.

In a preferred embodiment, step (a) comprises reacting
(A1) at least one bridged organosilane with at least two hydrolysable organosilane groups per molecule and
(A2) at least one organosilane with one hydrolysable organosilane group per molecule.

The term “hydrolysable organosilane group” refers to an organosilane group that is capable of undergoing hydrolysis and polycondensation in the presence of water, preferably by means of at least one hydrolysable substituent attached to the Si atom.

Throughout the present invention, the term “bridged organosilane” refers to a molecule with at least two hydrolysable organosilane groups which preferably carry hydrolysable substituents and which are connected to each other via an organic group which acts as a spacer group, preferably an alkylene group.

As bridged organosilane (A1) it is preferred to use at least one compound according to structure (A1-I) or (A1-II):

Y₃Si−R¹−SiY₃ (A1-I),

R²(SiY₃)₃ (A1-II),

wherein R¹ and R² both represent an organic group with from 1 to 20 carbon atoms, preferably 1, 2, 3, 4, 5, 6, 7, or 8 carbon atoms, which does not undergo hydrolysis in the presence of water (non-hydrolysable organic group) and wherein each Y represents a hydrolysable functional group which can be the same or different to the other Y and which can be selected independently.

Preferably R¹ is an alkylene, alkenylene or arylene group, particularly preferred a linear alkylene group. Preferred alkylene groups as R¹ are methylene, ethylene, propylene, in particular n-propylene, hexylene, in particular n-hexylene, and octylene, in particular n-octylene according to the formula —CₙH₂ₙ—, where n=1. 2, 3, 6 or 8.

Preferred alkenylene groups as R¹ are ethenylene, n-butenylene, iso-butenylene, n-hexenylene and n-octenylene according to the chemical formula —CₙH₂ₙ₋₂—, where n=2, 4, 6 or 8.

Preferred arylene groups as R₁ are 1,4-phenylene, 1,3-phenylene, 4,4′-biphenylene, 4,4″-terphenylene, 1,4-diphenylmethylene, 1.3-diphenylmethylene, 1,4-diphenylethylene 1,3-diphenylethylene, phenanthrylene, anthracylene and coumarin.

Preferably R² is an aliphatic, araliphatic or aromatic group, particularly preferred an aromatic or araliphatic group. The term “araliphatic group” throughout the present invention refers to a group containing aromatic and aliphatic moieties.

R² is preferably selected from the list consisting of

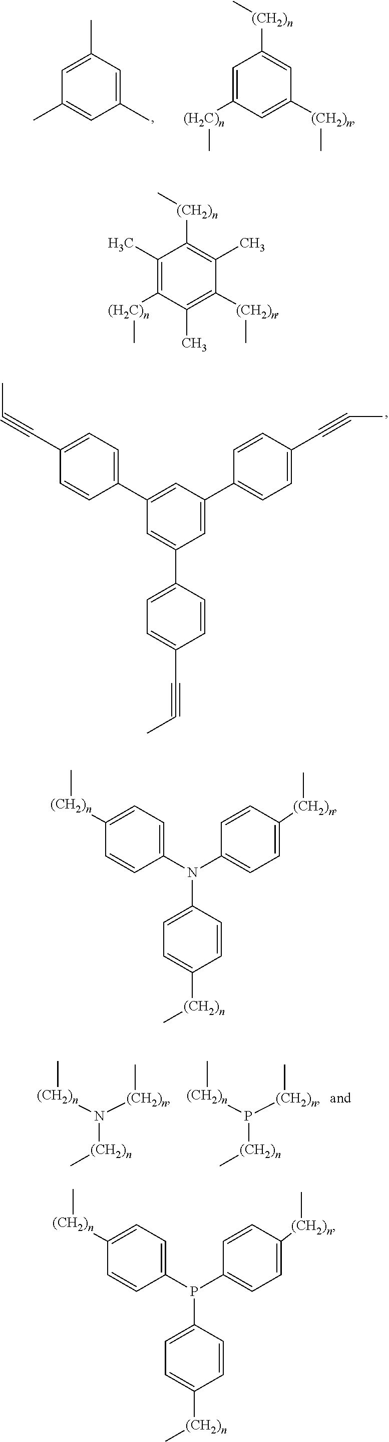

where n is 1, 2, 3 or 4.

In formula (A1-I) and (A1-II) each Y can be different or the same and represents a hydrolysable functional group. The hydrolysable functional groups Y in one molecule can be selected independently from each other.

Preferably Y is selected from hydroxy, methoxy, ethoxy, n-propoxy, iso-propoxy, n-butoxy, iso-butoxy, sec-butoxy, tert-butoxy, n-hexoxy, n-octoxy, n-decoxy, n-dodecoxy, n-hexadecoxy, n-octadecoxy, n-cyclohexoxy, vinoxy, phenoxy, benzoxy, phenylethoxy, halide methoxy, F, Cl, Br and I. Preferably all groups Y in one molecule are the same. If R¹ is an alkylene group then Y is preferably an alkoxy group, in particular ethoxy.

1,2-bis(triethoxysilyl)-ethane is particularly preferred as bridged organosilane (A1).

Preferably the organosilane (A2) is at least one compound according to structure (A2-I):

R³SiY₃ (A2-I),

wherein Y is a hydrolysable functional group and has the meaning as defined for component (A1) and R³ is a non-hydrolysable organic group. Preferably R³ is an aliphatic, araliphatic or aromatic organic group preferably containing at least one fluorine atom, in particular an alkyl, aryl or aralkyl group containing containing at least one fluorine atom. It is particularly preferred if R³ is selected from alkyl, aryl and aralkyl groups containing at least one fluorine atom. Without being bound to theory, it is believed that the fact that R³ is hydrophobic supports the self-assembly of the reactive mixture during pore formation and leads to homogeneously distributed pores.

Particularly preferred organosilanes (A2) are organosilanes according to the chemical structures (A2-II) or (A2-III),

Y₃Si−CₙH₂ₙ−CₘF₂ₘ₊₁ (A2-II),

Y₃Si−R⁴ (A2-III)

wherein each Y is a hydrolysable functional group which can be chosen independently and be the same or different and has the same meaning as defined for component (A1), n is 0, 1 or 2, m is 1, 2, 3, 4, 5 or 6 and R⁴ is H or a non-hydrolysable organic group selected from the group consisting of
alkyl, in particular methyl, ethyl, n-propyl, iso-propyl, n-butyl, iso-butyl, sec-butyl, tert-butyl, n-pentyl, iso-pentyl, sec-pentyl, tert-pentyl, cyclopentyl, n-hexyl, cyclohexyl, n-heptyl, cycloheptyl, n-octyl, n-neptyl, n-decyl, n-dodecyl, n-tetradecyl, n-hexadecyl and n-octadecyl,
alkenyl, in particular vinyl, propenyl, butenyl, hexenyl and octenyl, and
aryl, in particular phenyl, halide-phenyl, benzyl, halide-benzyl, phenylethyl, halide-methyl phenyl, halide-ethyl phenyl and halide-methyl.

It is very particularly preferred if the organosilane (A2) is selected from methyltriethoxysilane, phenyltriethoxysilane, tridecafluoro-1,1,2,2-tetrahydrooctyltriethoxysilane, 3,3,3-trifluoropropyl-trimethoxysilane (FTMS), and 3,3,3-trifluoropropyl-methylsilanediol.

If, according to the preferred embodiment discussed above, step (a) comprises reacting at least one bridged organosilane (A1) and at least one organosilane (A2), then the molar ratio of organosilane (A1) and organosilane (A2), A1/A2, can vary over a broad range from approximately 0.01 to approximately 100 and is preferably from 0.05 to 20, in particular from 0.15 to 6.

The person skilled in the art adjusts the molar ratio A1/A2 according to the particular needs concerning the properties of the porous material obtainable by the inventive method. The molar ratio A1/A2 influences the dielectric constant k of the resulting porous material as well as its mechanical properties. A molar ratio A1/A2 of larger than 1 yields a material with high mechanical strength combined with a low dielectric constant k. A molar ratio A1/A2 of lower than 1 yields a material with very low k-value combined with reasonable to good mechanical properties. Consequently, in a particularly preferred embodiment, the molar ratio A1/A2 is from 1.1 to 5. In yet another particularly preferred embodiment the molar ratio A1/A2 is from 0.15 to 0.9.

A solvent throughout the present invention refers to a fluid, preferably a liquid, which is capable of solving and/or dispersing organosilanes (A). Preferably, the solubility of the organosilanes (A) in solvent (C) is sufficiently high (within the range of molar ratios outlined further below) to obtain a homogenous solution.

The solvent (C) in principle can be any solvent suitable for performing sol-gel processes with organosilanes except for water which is a reactant according to step (a). Suitable solvents lead to a homogenous solution or dispersion of the reactive components. A precipitation or macrophase separation is to be avoided.

The solvent (C) is preferably selected according to the following criteria:
the solubility of water in the solvent (C) is at least 1 gram water per 100 g solvent, preferably at least 5 grams water in 100 g solvent, particularly preferred at least 10 grams water in 100 g solvent, and
solvent (C) has a boiling temperature of from 40 ° C. to 170 ° C., preferably of from 50 ° C. to 140 ° C.

It is preferred to use polar organic solvents as solvent (C). Preferably solvent (C) is selected from alcohols, ethers and ketones.

If solvent (C) is an alcohol, it can be selected from monofunctional alcohols (monoalcohols) or multifunctional alcohols, in particular diols and triols. A preferred triol is glycerol.

If solvent (C) is a monoalcohol, it is preferably selected from methanol, ethanol, n-propanol, iso-propanl, n-butanol, iso-butanol, sec-butanol, tert-butanol, n-pentanol, isopentanol, 2-methylbutanol, sec-hexanol, 2-ethylbutanol, sec-heptanol, tert-heptanol, n-octanol, 2-ethylhexanol, sec-octanol, benzyl alcohol and diacetone alcohol.

Preferred diols are ethylene glycol, 1,2-propylene glycol, 1,3-butylene glycol, pentadiol, 2-methyl pentanediol, hexandiol, 2,5-heptanediol, 2-ethyl hexanediol, diethylene glycol, dipropylene glycol, triethylene glycol, and tripropylene glycol.

Preferred are furthermore glycols (diols) which are alkoxylized or partially etherized, in particular ethylene glycol monomethyl ether, ethylene glycol monoethyl ether, ethylene glycol monopropyl ether, ethylene glycol monobutyl ether, ethylene glycol monohexyl ether, ethylene glycol monophenyl ether, ethylene glycol mono-2-ethylbutyl ether, di-ethylene glycol monomethyl ether, diethylene glycol monoethyl ether, diethyleneglycol monopropyl ether, diethyleneglycol monobutyl ether, diethylene glycol monohexyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, and polyhydric alcohol partial ether solvents, such as dipropyleneglycol monopropyl ether.

If the solvent (C) is an ether then tetrahydrofurane is particularly preferred.

If solvent (C) is a ketone it is preferably selected from acetone, methyl ethyl ketone, methyl-n-propyl methyl-n-butyl ketone, diethyl ketone, methyl-iso-butyl ketone, methyl-n-pentyl ketone, ethyl-n-butyl ketone, and methyl-n-hexyl ketone.

Mixtures of two or more than two of the above mentioned solvents are suitable, too.

In a preferred embodiment, step (a) of the inventive method comprises the following steps:
(a1) furnishing at least one organosilane (A),
(a2) bringing said organosilane (A) into contact with a solvent (C) yielding a mixture of (A) and (C),
(a3) adding water and preferably a catalyst to said mixture, and
(a4) reacting said at least one organosilane (A) with water to form a polymeric material.

Preferably, the steps are performed according to the sequence a1-a2-a3-a4.

In step (a3), water and the catalyst can be added jointly or separately, first the catalyst and then water or first water and then the catalyst.

The following preferred ranges and preferred embodiments apply to all different embodiments outlined above, in particular to all different organosilanens (A).

The amount of water is preferably selected such that the molar ratio of water to Si (calculated as Si atoms) is from 1 to 10, particularly preferred from 2 to 6.

The molar ratio of organosilane (A) to the solvent (C), A:C, in the reactive mixture of step (a) can range from approximately 1:1 to approximately 1:100, preferably from 1:2 to 1:20. in particular from 1:5 to 1:12, very particularly preferred from 1:7 to 1:11. In case more than one organosilane (A) is used such as at least one bridged organosilane (A1) and at least one organosilane (A2) as outlined above, then the molar ratio of organosilane (A) to the solvent (C) refers to the sum of the molar ratios of individual organosilanes (A) to the solvent (C).

The duration of step (a) can vary over a broad range. Typically the duration of step (a) ranges from 30 minutes to 2 weeks, preferably from 1 hour to 1 week, particularly preferred from 2 hours to 24 hours. The temperature during step (a) typically ranges from 0 to 160 ° C., preferably from 20 ° C. to 100 ° C. If the temperature is chosen too low it might lead to an incomplete and/or insufficient formation of polymeric material. A temperature which is chosen too high leads to a disadvantageously high reaction rate leading to insufficient pre-formation of pores.

The duration of step (a) is preferably chosen such that the viscosity of the solution of polymeric material is from 0.005 to 10 Pa.s, particularly preferred from 0.01 Pa.s to 2 Pa.s. In case the solution of polymeric material is applied to a substrate (B) prior to step (b) as outlined in more detail below, then the transfer from the solution to the substrate advantageously takes place at a viscosity of from 0.1 Pa.s to 2 Pa.s, particularly preferred from 0.2 Pa.s to 1 Pa.s.

If a catalyst is used, in principle any catalyst suitable for catalyzing the hydrolysis of organosilanes can be used. Suitable catalysts are in particular acids and bases. Preferred acids are outlined below. Suitable bases are in particular tetramethyl ammonia hydroxide, tetraethyl ammonia hydroxide and tetrapropyl ammonia hydroxide.

Preferably, the catalyst is an acid catalyst, preferably a strong acid such as a mineral acid or an organic acid, in particular a mineral acid.

The person skilled in the art of sol-gel science knows that the nature of the catalyst, i.e. acid or base, influences the porous structure of the material obtained by sol-gel processes in general. Base catalysts support a higher porosity and open pores with larger pore size. Acid catalysts support a lower pore volume, lower pore size and higher degree of closed cell structure. See for instance Brinker et al., Sol-Gel Science, Academic Press, San Diego, Calif. (USA) 1990. The exact porous structure on the other hand, which is a key factor for the final properties of the material, is influenced by a combination of many different process parameters as outlined in the present invention.

As mineral acid hydrochloric acid, hydrobromic acid, hydroiodic acid, boric acid, sulfuric acid, phosphoric acid, nitric acid, chloric acid, triflic acid, fluorosulfuric acid, trifluoro-methanesulfonic acid, fluoroantimoic acid, bromic acid, iodic acid, and periodic acid are in particular suitable.

As organic acid formic acid, acetic acid, propionic acid, butanoic acid, pentanoic acid, citric acid, oxalic acid, sulfonic acid, benzoic acid, lactic acid, glucuronic acid, trifluoroacetic acid, and trichloroacetic acid are in particular suitable.

The amount of acid is preferably selected such that the molar ratio of hydrolysable, i.e., active protons to the total number of silicon atoms in the organosilanes is from 0.0005 to 0.01. Preferably, the pH value of the resulting reaction mixture is from 0.5 to 5, in particular from 1 to 4 determined at the beginning of the reaction according to step (a) or (a4), respectively.

According to a preferred embodiment, subsequent to step (a4), the following step is executed: (a5) transferring said polymeric material to a substrate (B). It is also preferred to execute step (a5) subsequent to reacting at least one organosilane (A) with water in the presence of a solvent (C) to form a polymeric material according to step (a) of the present invention in any other embodiment discussed above.

Preferably, according to step (a5) the polymeric material is transferred in liquid form, particularly preferred as a sol, to the substrate (B). Preferably the polymeric material is transferred to the substrate (B) after having been filtered, preferably by means of a syringe membrane filter or a microfilter, preferably with a pore size of from 0.1 to 0.8 micrometers, in particular from 0.2 to 0.6 micrometers.

It is preferred to obtain the polymeric material in the form of a film attached to the surface of substrate (B) after the polymeric material was transferred. The thickness of the film can vary over a broad range. Preferably, the thickness ranges from 5 to 1500 nm, in particular from 10 to 1000 nm.

Suitable means for transferring the polymeric material obtained after step (a) or step (a4), respectively, to substrates are known to the person skilled in the art and are referred to as “coating methods”. The person skilled in the art selects the coating method depending on the nature of the substrate to be coated and the required thickness of the film.

In particular spin coating, dip coating, spray coating, flow coating, printing such as screen printing, chemical vapor deposition and similar techniques of transferring coatings in gaseous form such as plasma-enhanced CVD can be applied. Spin coating is particularly preferred.

As substrate (B) in principle any substrate can be used. It is possible to use pre-coated substrates or non-coated substrates. The substrate is selected by the person skilled in the art in light of the targeted application. Preferably, the substrate is a substrate useful for semiconductor applications. Preferably the substrate is a semiconductor substrate, in particular a silicon wafer preferably doped with B, P, As, Sb or Ga/As with a preferred doping level of from 10¹³ to 10¹⁶ per cm³. It is also possible to use semiconductor substrates other than silicon wafer substrates based on germanium, gallium arsenide, or indium antimony.

In a preferred embodiment, the substrate (B) is a semiconductor substrate and is present in pre-coated from, i.e. coated by a thin layer on top of the substrate, in the following referred to as “thin-film coating”. Such thin-film coatings on semiconductor substrates are known to the person skilled in the art and may serve various purposes such as the formation of electrical interconnects, protective layers against penetration, difussion or electromigration of metal atoms or cleaning etching chemicals, protective layers against laser or reactive ion etching, dielectric layers or semiconducting layers . Such thin-film coatings can for instance consist of titanium, chromium, nickel, copper, silver, tantalum, tungsten, osmium, platinum, gold, silicon dioxide, fluorination glass, phosphorus glass, boron-phosphorus glass, borosilicate glass, ITO glass, polycrystalline silicon, alumina, titanium dioxide, or zirconia.

The thin-film coating may also consist of silicon nitride, titanium nitride, tantalum nitride, boron nitride, hydrogen silsesquioxanes, methyl silsesquioxanes, amorphous carbon, fluorinated amorphous carbon, polyimides, or other block copolymers such as polydi-methylsiloxane, polyamic acid, polypromellitic dianhydrideoxydianiline (PMDA-ODA), biphenyltetracarboxylic dianhydridephenylenediamine (BPDA-PDA). fluorinated polyarylether, polyarylether, polyphenylquinoxaline or polyquinoline.

For the present invention it is preferred to transfer the polymeric material to a substrate (B) by means of spin coating. When using spin coating, the thickness of a resulting thin film is in the range of from 8 nm to 1000 nm and is obtained by means of controlling
i) the viscosity of a coating composition and
ii) the rotational speed of a spin coater.
   The method of spin coating and its parameters are known to the person skilled in the art.

Step (b)

According to the invention, in step (b) the polymeric material obtained after step (a) is subjected to a heat treatment.

The term “heat treatment” throughout the present invention refers to the application of an increased temperature, whereby increased temperature means a temperature of at least 25 ° C.

It is preferred to subject said polymeric material in step (b) to an increased temperature of from 25 to 150 ° C., in particular of from 30 to 120 ° C., particularly preferred of from 40 to 100 ° C. and very particularly preferred of from 45 ° C. to 80 ° C.

Step (b) generally can last from a few minutes to several hours. In particular, the duration of step (b) is from about 5 minutes to about 1 hour. Preferably, the duration of step (b) is from 5 minutes to 30 minutes.

The increased temperature according to step (b) can be applied constantly or it can be changed incrementally until it reaches at least one temperature satisfying the condition defined above.

During step (b) it is believed—without being bound by theory—that the porous structure is pre-formed or pre-stabilized during step (b). As a consequence of performing step (b), the amount of solvent in the polymeric network is reduced and the stability of the polymeric network is enhanced as a preparation for step (c).

The heat treatment according to step (b) can be applied by any means known to the person skilled in the art provided that such means offers a suitable control of the temperature. The person skilled in the art furthermore selects conditions concerning the atmosphere depending on the final application of the porous material such as the conditions in clean room facilities frequently used in semiconductor industry

Step (c)

According to the present invention, in step (c) the polymeric material obtained after having executed step (b) is brought into contact with at least one dehydroxylation agent (D).

Throughout the present invention the term “dehydroxylation agent” refers to a substance capable of reacting with hydroxyl groups present on the surface of the polymeric material. The at least one dehydroxylation agent (D) is subsequently referred to as dehydroxylation agents (D). Preferably the dehydroxylation agents (D) are silylation agents. i.e., substances capable of silylating hydroxyl groups on the surface of the polymeric material. The term “surface” thereby refers to the outer as well as to the part of the inner surface of the porous material which is accessible for liquids.

Dehydroxylation agents (D) according to the following structures (D-I) and/or (D-II) are preferred:

(R⁵)₃SiY (D-I),

(R⁵)₃Si−Q−Si(R⁵)₃ (D-II),

wherein each R⁵ can be selected independently from each other and can be the same or different and reflects a non-hydrolysable organic group with from 1 to 30 carbon atoms, Y is a hydrolysable functional group and Q is NH, PH, monoatomic sulfur or monoatomic oxygen.

R⁵ is preferably selected from hydrogen, alkyl, alkenyl, phenyl, halidealkyl, halidealkenyl, halidephenyl, benzyl, halidebenzyl, phenylethyl, halidmethyl phenyl, halidethyl phenyl or halidemethyl. Alkyl and alkenyl groups are particularly preferred as R⁵.

Preferred alkyl groups are methyl, ethyl, n-propyl, iso-propyl, n-butyl, iso-butyl, sec-butyl, tert-butyl, n-pentyl, iso-pentyl, sec-pentyl, tert-pentyl, cyclopentyl, n-hexyl, cyclo-hexyl, n-heptyl, cycloheptyl, n-octyl, n-neptyl, n-decyl, n-dodecyl, n-tetradecyl, n-hexadecyl and n-octadecyl. Preferred alkenyl groups are vinyl, propenyl, butenyl, hex-enyl and octenyl.

Y is preferably selected from hydroxy, methoxy, ethoxy, n-propoxy, iso-propoxy, n-butoxy, iso-butoxy, sec-butoxy, tert-butoxy, n-hexoxy, n-octoxy, n-decoxy, n-dodecoxy, n-hexadecoxy, n-octadecoxy, n-cyclohexoxy, vinoxy, phenoxy, benzoxy, phenylethoxy, halide methoxy, F, CI, Br and I. It is particularly preferred if Y is a halide group, in particular Cl or Br.

The dehydroxylation agents (D) can be applied as a pure substance or as a solution. It is preferred to apply the dehydroxylation agent (D) as a solution in a solvent (C′). Solvent (C′) can be the same or different to solvent (C).

Preferably, solvent (C′) is selected according to the following criteria:
the solubility of the dehydroxylation agents (D) in solvent (C′) is sufficiently high to obtain a homogenous solution with concentrations of at least 5 wt.-%, and
solvent (C′) has a boiling temperature of from 40 ° C. to 170 ° C., preferably of from 60 ° C. to 140 ° C.

Preferably, solvent (C′) is non-polar. It is particularly preferred to use toluene as solvent (C′). The concentration of the dehydroxylation agents (D) in solvent (C′) preferably is from 5 to 100 wt % where 100% by weight refers to the application as a pure substance. The concentration of (D) in solvent (C′) is particularly preferred from 5 to 50 wt.-%, in particular from 5 to 20 wt.-%. If more than one dehydroxylation agent (D) is used it can be applied as mixture in pure state or in solution or it can be applied separately.

The dehydroxylation agents (D) can be applied by different means. Suitable means provide an intimate contact between the polymeric material and the dehydroxylation agents (D). Preferably, the polymeric material obtained after having executed step (b) is soaked with the at least one dehydroxylation agent (D) which is present in liquid form, preferably as a solution. The person skilled in the art chooses the amount of dehydroxylation agents (D) such that an efficient reaction with the reactive groups on the surface of the polymeric material is achieved. It is advantageous to apply the dehydoxylation agents (D) in large excess of the reactive functional groups present on the surface of the polymeric material.

The temperature applied during the dehydroxylation step (c) typically ranges from 25 to 100 ° C. The duration of step (c) typically ranges from 1 minute to 12 hours, preferably from 5 minutes to 4 hours.

Particularly preferred dehydroxylation agents (D) are bis(trimethylsilyl)amine (also known as hexamethyldisilazane, HMDS), trimethylchlorosilane, triethylchlorosilane, and triphenylchlorosilane. HMDS is very particularly preferred.

Step (d)

According to step (d) of the inventive method, the polymeric material obtained after step (c) is subjected to electromagnetic radiation and/or to a further heat treatment.

Subjecting said polymeric material to electromagnetic radiation and/or to a further heat treatment causes curing and/or crosslinking of the polymeric material. In step (d) of the inventive method it is therefore preferred to cure said polymeric material by means of electromagnetic radiation and/or to a further heat treatment. As a consequence of performing step (d), the mechanical stability of the network is increased without compromising the dielectric constant.

According to a first preferred embodiment, the polymeric material obtained after step (c) is subjected to a further heat treatment.

The temperature applied in step (d) according to this first preferred embodiment can vary over a broad range. Preferably, the temperature applied in step (d) is from 100 to 800 ° C., particularly preferred from 250 to 650 ° C., very particularly preferred from 300 to 600 ° C., in particular from 350 ° C. to 550 ° C.

According to this first preferred embodiment, it is preferred to perform step (d) pursuant to the invention under an inert or reductive atmosphere where “inert” means that the atmosphere does not react with the polymeric material. Preferably, the atmosphere is essentially free of oxygen and water, such as an atmosphere consisting of nitrogen or a mixture of nitrogen and hydrogen. Suitable inert atmospheres preferably consist of nitrogen or noble gases, in particular argon. Mixtures of different inert gases are suitable, too. A suitable reductive atmosphere is in particular a mixture of one or more of the before mentioned inert gases with hydrogen. If the temperature applied or reached in step (d) is 250 ° C. or higher, then it is particularly preferred to use an inert or reductive atmosphere which is essentially free of oxygen.

Preferably, during step (d) the atmosphere is applied by means of a continuous inert gas flow or a continuous flow of a reductive atmosphere. The flow rate preferably is from 0.1 to 50 normal liters per hour, particularly preferred from 0.2 to 10 normal liters per hour.

In principle any means of heating can be used. Preferably a furnace or oven is used provided that it does provide sufficient control of temperature and of the atmosphere. The temperature can be changed incrementally or can be applied constantly during execution of step (d).

If the temperature is changed incrementally—which is preferred—, then the temperature ramp applied to the polymeric material, preferably of the film, is preferably from 2 to 20 K/min, particularly preferred from 5 to 15 K/min, very particularly preferred from 6 to 10 K/min. If the temperature is changed incrementally then the preferred temperature range defined above refers to the maximum temperature.

The duration of the further heat treatment according to step (d) can be from a few minutes to several days, preferably from 15 minutes to 15 hours, particularly preferred from 30 minutes to 6 hours, very particularly preferred from 45 minutes to 3 hours.

According to a second preferred embodiment, the polymeric material obtained after step (c) is subjected to electromagnetic radiation. Subjecting a material to electromagnetic radiation in the following is referred to as “irradiation”.

Electromagnetic radiation must be differentiated from thermal radiation which is known to inevitably occur as radiation emitted from an object due to the object's temperature. The emitted wave frequency distribution of thermal radiation only depends on temperature and for a genuine black body is given by Planck's law of radiation.

The terms “electromagnetic radiation” and “irradiation” both do not comprise thermal radiation. Therefore, according to step (d) of the inventive method, the polymeric material obtained after step (c) is subjected to—and preferably cured by means of—electromagnetic radiation other than thermal radiation from the surrounding of the polymeric material. The surrounding is anything that emits thermal radiation which is absorbed by the polymeric material.

The term “irradiation” causes the absorption of energy by means of electromagnetic waves from a radiation source which emits electromagnetic radiation in addition to the thermal radiation stemming from the surrounding of the polymeric material. Consequently, according to the present invention, said polymeric material is subjected to electromagnetic radiation in addition to thermal radiation. It is therefore mandatory to use a source of electromagnetic radiation in addition to any source of thermal radiation possibly present in the surrounding of the polymeric material. The absorption of energy from electromagnetic waves occurs in addition to the heat transfer, which is the passage of thermal energy from a hot to a colder body and which is known to occur via thermal radiation, thermal convection and/or thermal conduction.

It is known to the person skilled in the art that electromagnetic radiation in most cases exhibits a wavelength distribution (in the following referred to as “wavelengths”). The electromagnetic radiation applied in step (d) preferably exhibits a wavelength distribution in a range covering the microwave regime via the infrared (IR) and ultraviolet regime to the X-ray regime. Preferably, the electromagnetic radiation applied in step (d) has wayelengths in the range of from 0,1 nm to 100 cm, in particular from 1 nm to 10 cm.

The intensity of the electromagnetic radiation according to step (d) of this second preferred embodiment is chosen such that it provides an effective curing and/or crosslinking of the polymeric material.

The electromagnetic radiation preferably exhibits wavelengths in the range of ultraviolet (UV), particularly from 10 nm to 400 nm, infrared (IR), particularly from 1 μm to 1000 μm, or microwave (MW), particularly from 1 mm to 10 cm. Other suitable sources of electromagnetic radiation are electron beams, gamma ray sources and sources of ionizing radiation.

It is preferred to subject the polymeric material to ultraviolet (UV) radiation, in particular to UV radiation with wavelengths of from 10 to 400 nm, preferably from 50 to 300 nm, or to microwave radiation, in particular of microwave radiation with wavelengths of from 1 mm to 20 cm, preferably from 2 mm to 10 cm.

UV radiation is particularly preferred, in particular UV radiation with wavelengths of from 10 to 400 nm, preferably of from 20 to 300 nm. The UV light employed for the radiation preferably has a power of from 0.1 to 3000 mW/cm², in particular from 10 to 1000 mW/cm².

The intensity in a specific wavelength range is preferably chosen such that it is sufficient to cure and/or crosslink the polymeric material. It is preferred if at least 30%, preferably at least 50%, in particular at least 70% of the energy emitted (as electromagnetic radiation) by the source of the electromagnetic radiation is emitted within the specified wavelength range.

UV radiation as a means of curing silica-based low-k materials is in principle known to the person skilled in the art and for instance described in WO-2006/132655 and EP-A 1 122 333.

The ultraviolet radiation can be generated by UV energy sources known to the person skilled in the art such as mercury arc lamps, deuterium lamps, metal halide lamps, and halogen lamps. The UV light source can be laser driven, microwave driven, an arc discharge, a dielectric barrier discharge, electron impact generated or the like.

It is preferred to perform step (d) according to the invention, in particular the UV irradiation process, in a closed chamber which can be purged with gas to create inert or reductive atmosphere where “inert” means that the atmosphere does not react with the polymeric material. Preferably, the atmosphere is essentially free of oxygen and water, such as an atmosphere consisting of nitrogen or a mixture of nitrogen and hydrogen. Suitable inert atmospheres preferably consist of nitrogen or noble gases, in particular argon. Mixtures of different inert gases are suitable, too. A suitable reductive atmosphere is in particular a mixture of one or more of the before mentioned inert gases with hydrogen.

According to a third preferred embodiment of the present invention, step (d) of the inventive method comprises the following steps:
(d1) subjecting said polymeric material to electromagnetic radiation, and
(d2) subjecting said polymeric material to a further heat treatment, wherein steps (d1) and (d2) are performed either simultaneously or subsequently to each other, in the latter case first the heat treatment and then the irradiation or first the irradiation and then the heat treatment.

If steps (d1) and (d2) are performed simultaneously, it is nevertheless not only comprised by the term “simultaneously” but also preferred if step (d2) is started first before step (d2) is then performed leading to a simultaneous execution of both steps.

Preferably step (d) of the present invention is performed by executing steps (d1) and (d2) simultaneously. If steps (d1) and (d2) are performed subsequently to each other then it is preferred to perform step (d1) first and then step (d2). Alternatively steps (d1) and (d2) can be performed subsequently to each other but overlapping time-wise. It is particularly preferred though to perform steps (d1) and (d2) simultaneously as outlined above.

Preferred conditions for the optional heat treatment according to step (d2) are outlined below. It is however also possible to not apply an increased temperature (heat treatment) or to not control temperature during step (d) even though the embodiments comprising steps (d1) and (d2) is preferred.

If the polymeric material is subjected to a further heat treatment either simultaneously or prior to step (d1) or starting prior to step (d1) or starting after step (d1), the temperature can be changed incrementally or can be applied constantly.

In the different preferred embodiments comprising steps (d1) and (d2) as outlined above, the temperature applied in step (d2) can vary over a broad range. Preferably, the temperature applied in step (d2) is from 50 to 650 ° C., particularly preferred from 100 to 550 ° C., very particularly preferred from 200 to 500 ° C., in particular from 250 ° C. to 450 ° C. If the temperature applied or reached in step (d2) is 250 ° C. or higher, then it is particularly preferred to use an inert or reductive atmosphere which is essentially free of oxygen.

If steps (d1) and (d2) are executed simultaneously, then during step (d1) of the invention, in particular during the UV irradiation process, it is preferred to keep the polymeric material essentially at constant temperature at the same time preferably inside a closed chamber. It is therefore preferred to keep the temperature of the polymeric material constant during step (d1), preferably at a temperature of from 50 to 550 ° C., particularly preferred from 100 to 550° C., in particular from 100 to 400 ° C., very particularly preferred from 150 to 400 ° C. The temperature can be controlled by any means known to the person skilled in the art such as a conventional heating chamber including ovens, a microwave irradiation source, an infrared light source, an optical light source, a hot surface, or the UV light source itself. An increased temperature can be applied by means of a conventional heating source mainly leading to heat transfer by means of convection and/or heat conduction along a temperature gradient.

If the temperature in step (d2) is changed incrementally—which is particularly preferred if not overlapping with the execution of step (d1)—, then the temperature ramp applied to the polymeric material, preferably of the film, is preferably from 2 to 20 K/min, particularly preferred from 5 to 15 K/min, very particularly preferred from 6 to 10 K/min. If the temperature is changed incrementally then the preferred temperature range defined above refers to the maximum temperature. The temperature ramp can be controlled by controlling the power of temperature source.

Concerning all embodiments of step (d), during step (d) the atmosphere preferably is applied by means of a continuous inert gas flow or a continuous flow of a reductive atmosphere. The flow rate preferably is from 0.1 to 50 normal liters per hour, particularly preferred from 0.2 to 10 normal liters per hour.

The duration of step (d) can be from a few seconds to several days, preferably from 15 seconds to 8 hours, particularly preferred from 60 seconds to 2 hours, very particularly preferred from 180 seconds to 1 hour.

During UV irradiation the pore size distribution and the porosity do not change significantly. Irradiation by means of UV leads to dielectric films showing less shrinkage and less cracking during the curing process compared to conventional heat treatment.

In an alternative embodiment of step (d) of the inventive method, the polymeric material obtained after step (c) is subjected to microwave radiation, preferably with wavelengths in the range of from 1 mm to 10 cm.

It is known that the efficiency of heat transfer from a conventional heat source into a material is strongly influenced by the thermal conductivity of the particular material. On the other hand, it is known to the person skilled in the art that the heating rate and efficiency of microwave radiation strongly depends on the dielectric properties of the material. Heating by means of microwave radiation typically heats inner parts of a material more effectively compared to conventional heating. Without being bound by theory it is believed that microwave energy can selectively and effectively couple with polar O—H bonds of silanol groups in the polymeric materials, which effectively supports the condensation of silanol groups, leaving the non polar bridged and terminal organic groups inactive during the curing process which is not possible with conventional heating.

Without being bound by theory, as a consequence of step (d) the degree of polymerization, i.e., the degree of crosslinking and the crosslinking density, is increased and the pore size and porosity is reduced by co-condensation of adjacent silanol groups within the porous material. As a consequence of performing step (d), the mechanical stability of the network is increased.

Step (e)

The polymeric material obtained after having executed step (d) preferably is subjected to a second dehydroxylation step according to step (e):
(e) bringing the polymeric material obtained after step (d) into contact with at least one dehydoxylation agent (D).

The preferred embodiments and conditions of step (e) are identical to those that have been described under step (c). Preferred dehydroxylation agents (D) are identical to those described under step (c).

Properties of the porous material

Throughout the present invention, a low-k material refers to a material that exhibits a dielectric constant k of below 3.0 and an ultralow-k material refers to a material that exhibits a dielectric constant k of below 2.4.

Preferably the porous materials according to the present invention exhibit a dielectric constant k of below 3.5, preferably of below 3 (low-k material), in particular of below 2.4 (ultralow-k material).

The dielectric constant k is the relative static permittivity measured at a frequency of 1 kHz at 20 ° C. according to the metal-insulator-semiconductor method known to the person skilled in the art and described in Fjeldly et al., Introduction to Device Modeling and Circuit Simulation, Eiley, N.Y., 1998.

The material obtainable by means of the method according to the invention is a porous material. Preferably, the porous material is microporous. Generally, a porous material contains voids or tunnels of different shapes and sizes. Microporous materials are materials with micropores. Micropores pursuant to this invention are pores with diameters smaller than 2 nm in accordance to the IUPAC classification. Such microporous materials typically have large specific surface areas.

A microporous material is referred to as a material with a number-average pore diameter of 2 nm or below as measured by means of transmission electron microscopy in combination with image analysis of at least 500 pores using a statistically meaningful sample.

In the context of the present invention it is important to differentiate between open and closed cells (and/or voids and/or tunnels). Throughout the present invention the term “open cell porosity” refers to pores which are accessible to Argon gas, whereas the term “closed cell porosity” refers to pores which are not. The volume fraction of open cell pores (in Vol.-% of the total pore volume) and the volume fraction of closed cell pores (in Vol.-% of the total pore volume) together is 100%. The sum of the volumes of closed and open cell pores, the total pore volume, in relation to the total volume of the material is referred to as porosity (in Vol.-%).

The porous material according to the present invention exhibits open cell porosity as well as closed cell porosity.

The open cell porosity is preferably characterized by measurement of adsorption isotherms. Such adsorption isotherms only detect the open cell porosity. Consequently specific surface derived from an adsorption isotherm measurement only reflects the specific surface stemming from the open cell porosity.

The person skilled in the art knows that within the argon adsorption isotherm the area of low argon pressure is characteristic for the microporosity. A porous material pursuant to the invention preferably adsorbs a quantity of at least 10 cm³ argon per gram sample in a volumetric measurement of the adsorption isotherm at standard temperature and pressure (STP) at an absolute pressure of 2670 Pa. The adsorption isotherm thereby is recorded at a temperature of 87,4 K with a equilibration interval of 10 s pursuant to DIN 66135-1. It is preferred if the porous material obtainable according to the present invention is a microporous material. A microporous material preferably adsorbs a quantity of at least 30 cm³ argon per gram sample in a volumetric measurement of the adsorption isotherm at standard temperature and pressure (STP) at an absolute pressure of 2670 Pa due to open cell microporosity.

Different methods can be applied to calculate specific micropore surface areas and micropore volumes from the above described argon adsorption isotherm without contribution of larger pores. One of those methods is the DFT (density functional theory) method according to Olivier and Conklin as outlined in Olivier, J. P., Conklin, W. B., and v. Szombathely, M. in “Characterization of Porous Solids Ill” (J. Rouquerol, F. Rodrigues-Reinoso, K. S. W. Sing, and K. K. Unger, Eds.), p. 81 Elsevier, Amsterdam, 1994, subsequently referred to as Olivier-Conklin-DFT method.

The porous material can be further characterized by the method of Brunauer. Emmet and Teller (BET). The BET method pursuant to the present invention refers to the analysis of nitrogen adsorption isotherms at a temperature of 77,35 K according to DIN 66131. The BET method is known not to be selective for micropores.

Preferably, the porous material adsorbs at least 10 cm³ argon per gram sample according to the above-described method at an absolute pressure of 2670 Pa and a temperature of 87,4 K according to DIN 66135-1. More preferably, the porous material adsorbs at least 20 cm³ argon per gram sample, in particular at least 30 cm³/g, in the above-described method at an absolute pressure of 2670 Pa and a temperature of 87,4 K according to DIN 66135-1.

It is furthermore preferred if the porous material adsorbs at least 5 cm³ argon per gram sample, preferably at least 10 cm³, in particular at least 15 cm³, in the above-described method at an absolute pressure of 1330 Pa and a temperature of 87,4 K according to DIN 66135-1.

For structural reasons, the porous material according to this invention has an upper limit concerning the amount of argon adsorbed under to the above-described conditions. Such an upper limit is for example 500 cm³ argon per gram sample according to the above described method at an absolute pressure of 2670 Pa and a temperature of 87,4 K and for example 400 cm³ argon per gram sample according to the above described method at an absolute pressure of 1330 Pa and a temperature of 87.4 K.

It is preferred if the porous material pursuant to this invention has a cumulative area of micropores (pores smaller than 2nm) of at least 30 m²/g, preferably at least 50 m²/g, in particular at least 70 m²/g, for instance at least 100 m²/g determined by the Olivier-Conklin-DFT method analyzing the argon adsorption isotherm recorded at a temperature of 87,4 K according to DIN 66135-1 when applying the following modeling parameters: slit pores, non-negative regularization, no smoothing.

To be still usable, an upper limit for the cumulative specific surface area of pores with diameters smaller than 2 nm is for instance around 600 m²/g. For instance, the porous material has a cumulative specific surface area of pores with diameters smaller than 2 nm of from 40 to 500 m²/g, in particular from 100 to 400 m²/g.

Preferably, the porous material has a specific surface area of at least 50 m²/g measured by the BET method. More preferably, nanoparticulate component (B) has a surface area of at least 100 m²/g measured by the BET method, even more preferred at least 200 m²/g.

The open and closed cell pores can be characterized by means of transmission electron microscopy combined with image analysis. The porosity (open and closed cell porosity) throughout the present invention is obtained by means of a combination of methods.

The porous material obtainable pursuant to the invention is preferably characterized as a thin film by means of specular X-ray reflectivity (SXR). Specular X-ray reflectometry is a technique for investigating the near-surface structure of many materials. It probes the electron density with a depth resolution of less than one nm for depths of up to several hundred nm. The method involves measuring the reflected X-ray intensity as a function of X-ray incidence angle (typically small angles are used). It is known to the person skilled in the art that SXR accurately determines the thickness, density, roughness and interfacial thickness of thin films on substrates as for instance described in Ferrari et al., J. Phys. Rev. B62 (2000) on page 11089. The term “thin film” throughout the present invention refers to a film with a thickness of from about 1 nm to about 1000 nm present on a substrate.

From the difference between the density of the dielectric film according to SXR and the density of a material with identical chemical composition but without pores, the total porosity (combined value for both, closed and open pores) is derived.

The closed cell porosity is calculated according to the following equation: Closed cell porosity (in Vol.-%)=total porosity from SXR (in Vol.-%) minus open cell porosity (in Vol.-%) from Ar adsorption analysis.

The volume fraction of closed pores relative to the total volume of pores can vary over a moderately broad range and is preferably from 50 to 99 Vol.-%, particularly preferred from 60 to 98 Vol.-% and in particular from 70 to 97 Vol.-%.

The density of the porous material according to the present invention is preferably from 0.4 to 1.9 g/cm³, in particular from 0.7 to 1.5 g/cm³.

The inventive process yields materials with a porous structure which is advantageous compared to materials obtained according to the prior art. The so obtained materials in particular exhibit a reduced dielectric constant in combination with improved mechanical properties.

The porous material obtainable by the method according to the invention is in particular useful as material for electrical insulation layers for microelectronic devices. The porous material obtainable may also be applied to gas separation membranes, display materials, chemical sensors, hydrophobic surfaces, insulators, packaging materials, and selective catalysis.

In addition to the insulation layer, the compositions and process can be used for the manufacturing of anti-reflective coatings, prisms, waveguides, refractive optics and adhesion promoters in microelectronic fabrication.

1. Method of making a porous material comprising the following steps in the order a-b-c-d:
(a) reacting at least one organosilane (A) with water in the presence of a solvent (C) to form a polymeric material.
(b) subjecting said polymeric material to a first heat treatment.
(c) bringing said polymeric material into contact with at least one dehydroxylation agent (D),
(d) subjecting said polymeric material to electromagnetic radiation and/or to a further heat treatment.

2. Method of making a porous material according to claim 1, wherein step (b) comprises subjecting said polymeric material to a temperature of from 30 to 150° C.

3. Method of making a porous material according to claim 1, wherein step (d) comprises curing said polymeric material by means of electromagnetic radiation other than thermal radiation.

4. Method of making a porous material according to claim 1, wherein according to step (d) said polymeric material is subjected to a temperature of from 250 to 650° C.

5. Method of making a porous material according to claim 1, wherein step (d) further comprises (d1) subjecting said polymeric material to electromagnetic radiation, and (d2) subjecting said polymeric material to a further heat treatment.

6. Method of making a porous material according to claim 1, wherein step (d) comprises subjecting said polymeric material to ultraviolet radiation.

7. Method of making a porous material according to claim 1, wherein the dehydroxylation agent (D) is hexamethyldisilazane.

8. Method of making a porous material according to claim 1, wherein step (a) comprises reacting at least one organosilane (A) with water in the presence of a solvent (C) and an acid to form a polymeric material.

9. Method of making a porous material according to claim 1, wherein step (a) comprises applying said polymeric material to a substrate (B).

10. Method of making a porous material according to claim 1, wherein step (a) comprises reacting at least one bridged organosilane with at least two hydrolysable organosilane groups per molecule (A1) and at least one organosilane with one hydrolysable organosilane group per molecule (A2) to form a polymeric material.

11. Method of making a porous material according to claim 1, wherein step (a) comprises reacting at least one bridged organosilane (A 1) and at least one organosilane (A2), wherein
(A1) is at least one compound according to structure (A1-I) or (A1-I)
Y₃Si−R¹−SiY₃ (A1-I),
R²(SiY₃)₃ (A1-II),
wherein R¹ and R² both represent a non-hydrolysable organic group with from 1 to 20 carbon atoms and wherein each Y represents a hydrolysable functional group which can be selected independently from each other and can be the same or different, and
(A2) is at least one compound according to structure (A2-I)
R³SiY₃ (A2-I),
wherein Y has the meaning as defined above and R³ is an aliphatic, araliphatic or aromatic organic group.

12. Method of making, a porous material according to claim 1, wherein the porous material exhibits a dielectric constant k of below 3.

13. Method of making a porous material according to claim 1, wherein the dehydroxylation agent (D) is selected from at least one compound according to formula (D-I) or (D-II),
(R⁵)₃Si Y (D-I),
(R⁵)₃Si−Q−Si(R⁵)₃ (D-II)
wherein each R⁵ can be selected independently from each other and can be the same or different and represents a non-hydrolysable group selected from hydrogen, alkyl, alkenyl, aryl, aralkyl, halidearyl, and halidealkyl, and
Y is a hydrolysable functional group selected from hydroxy, methoxy, ethoxy, n-propoxy, iso-propoxy, n-butoxy, iso-butoxy, sec-butoxy, tert-butoxy, n-hexoxy, n-octoxy, n-decoxy, n-dodecoxy, n-hexadecoxy, n-octadecoxy, n-cyclohexoxy, vinoxy, phenoxy, benzoxy, phenylethoxy, halide methoxy, F, Cl, Br and I. and
Q is selected from —NH—, —PH—, monoatomic sulfur and monoatomic oxygen.

14. Porous material obtainable according to any of claim 1.

15. Semiconductor device comprising a porous material according to claim 14.

16. Electronic component. comprising a porous material according to claim 14.

17. Use of the porous material according to claim 14 for electrical insulation.

18. Use of the porous material according to claim 14 in microelectronic devices, membranes, displays or sensors.

19. Electronic component comprising a semiconductor device according to claim 15.

20. Method of making a porous material according to claim 5, wherein said polymeric material is subjected to a further heat treatment at a temperature of from 100 to 550° C.
